(19) United States
(12) Patent Application Publication
(10) Pub. No.: US 2017/0090782 A1
(43) Pub. Date: Mar. 30, 2017

(54) WRITING MANAGEMENT METHOD AND WRITING MANAGEMENT SYSTEM FOR SOLID STATE DRIVE

(71) Applicant: APACER TECHNOLOGY INC., New Taipei City (TW)

(72) Inventor: Jiunn-Chang Lee, New Taipei City (TW)

(21) Appl. No.: 14/942,630

(22) Filed: Nov. 16, 2015

(30) Foreign Application Priority Data
Sep. 30, 2015 (TW) 104132033

(51) Int. Cl. G06F 3/06; G06F 12/10; G06F 12/02

(52) U.S. Cl. CPC G06F 3/0616; G06F 3/0653; G06F 3/0679; G06F 12/0246; G06F 12/1009; G06F 2212/1044; G06F 2212/2022; G06F 2212/7201

(57) ABSTRACT

A writing management method and a writing management system for a solid state drive are provided. The writing management method includes the following steps. Firstly, plural write commands are transmitted to a firmware so as to write at least one data to the solid state drive, wherein each of the plural write commands contains a logical block address and a sector count. Then, the logical block addresses and the sector counts of the plural write commands are sequentially stored to the firmware. Then, an application program sequentially reads the logical block addresses and the sector counts. Then, a sequential write ratio is determined according to the logical block addresses and the sector counts. Afterwards, the application program updates the firmware to a first firmware according to the sequential write ratio.

### FIELD OF THE INVENTION

The present invention relates to a writing management method and a writing management system for a solid state drive, and more particularly to a writing management method and a writing management system for managing the write data and updating the firmware according to the writing action of a solid state drive.

### BACKGROUND OF THE INVENTION

A solid state drive (SSD) is a storage device using non-volatile memories as permanent memories. Generally, the data accessing speed of the non-volatile memory is between the data accessing speed of the volatile memory and the data accessing speed of the conventional hard disk. After data are written to the non-volatile memory, if no power is supplied to the non-volatile memory, the data are still retained in the non-volatile memory. Consequently, the non-volatile memory is suitable as the replacement for the conventional hard disk. Moreover, NAND-based flash memories are widely used in a variety of electronic devices. Moreover, a flash memory and a corresponding control chip can be integrated into a solid state drive.

Generally, a NAND-based flash memory chip comprises plural blocks. Each block consists of plural pages. Each page contains a user area and a space. The user area is used for storing the write data. The space is used for storing mapping information and an error correction code (ECC). Due to the inherent properties of the flash memory, at least one page is written at a time during the writing operation, but a block is erased during the erasing operation. Moreover, each block of the flash memory has a limited erase count.

Since the physical properties of the solid state drive are different from the physical properties of the conventional hard disk, the solid state drive is simulated as the conventional hard disk by using a flash translation layer (FTL). Since the NAND-based flash memory cannot perform an in-place update action at the same address, FTL will write and store the repeatedly-updated data into other addresses and use a mapping table to record the updated addresses. After all blocks become used blocks and no additional free block is left to store the write data, FTL will call a garbage collection (GC) operation to release the storing space of the invalid page in the used blocks. In addition, FTL may perform a wear leveling operation to extend the use life of the flash memory and perform an error correction to verify the data accuracy.

Generally, FTL can perform a high-resolution mapping operation, a low-resolution mapping operation and a hybrid mapping operation. The high-resolution mapping operation (e.g., a page-level mapping operation) implements the address conversion at a smaller unit. This mapping operation has an excellent random write speed, but a page table is required to record the corresponding address of each page. The low-resolution mapping operation (e.g., a block-level mapping operation) implements the address conversion at a larger unit. Since this mapping operation is implemented at the unit of a block, the required table is very small. However, if the write data is smaller than one block, the block should be supplemented with additional data. In other words, for writing only a small amount of data, the low-resolution mapping operation needs many additional copying actions. Consequently, the random accessing performance of the low-resolution mapping operation is usually unsatisfactory. The hybrid mapping operation is the hybrid of the high-resolution mapping operation and the low-resolution mapping operation. That is, the new data are written into log blocks by the page-level mapping operation, and a page table is used to record the corresponding addresses of the pages of the log blocks. The hardware cost of performing the hybrid mapping operation is between the hardware cost of performing the page-level mapping operation and the hardware cost of performing the block-level mapping operation. However, the hybrid mapping operation still has some drawbacks. For example, after the log blocks become used blocks, FTL will garbage collection (GC) operation to release the storing space of the invalid data in the used blocks. Moreover, for implementing the hybrid mapping operation, the valid data in the log blocks and the invalid data in the same logic block have to be copied to the new blocks and arranged as the data blocks. Since a lot of copying actions and erasing actions are required, the performance of the solid state drive is deteriorated.

For facilitating the user to realize the operating status of the solid state drive, an S.M.A.R.T monitoring system is usually built in the solid state drive to provide information about the operating status of the solid state drive. According to the operating status, the user can evaluate the use life of the solid state drive. Since different hosts have different use conditions and different writing modes, the results of evaluating the use life of the solid state drive have large errors. Moreover, since the writing modes are different, the firmware of the solid state drive has a large error. Under this circumstance, surplus data are possibly moved and written. For example, if the FTL of the solid state drive implements the low-resolution mapping operation and the write data is usually smaller than one block, the accessing efficiency is very poor and the use life of the solid state drive is reduced. On the other hand, if the FTL of the solid state drive implements the high-resolution mapping operation and the write data contains plural successive blocks, the random writing speed is no longer satisfied.

### SUMMARY OF THE INVENTION

An object of the present invention provides a writing management method and a writing management system for extending the use life of a solid state drive so as to be applied to the hosts with different use conditions and different writing modes.

Another object of the present invention provides a writing management method and a writing management system for enhancing the accessing efficiency of a solid state drive so as to be applied to the hosts with different use conditions and different writing modes.

In accordance with an aspect of the present invention, there is provided a writing management method of a solid state drive. The writing management method includes the following steps. In a step (a), N write commands are transmitted to a firmware so as to write at least one data to the solid state drive, wherein each of the N write commands contains a logical block address and a sector count. In a step (b), the logical block addresses and the sector counts of the N write commands are sequentially stored to the firmware. In a step (c), an initial value of a positive integer j is set as 1, and an initial value of a sequential write count value is set as 0, wherein the positive integer j is smaller than N. In a step (d), the firmware judges whether there is a sequential write relationship between the j-th write command and the (j+1)-th write command. If there is the sequential write relationship, the sequential write count value is increased by 1. In a step (e), if the positive integer j is smaller than (N−1), the positive integer j is increased by 1, and the step (d) is repeatedly done. In a step (f), the firmware divides the sequential write count value by (N−1) to obtain a sequential write ratio. In a step (g), an application program reads the sequential write ratio of the firmware. In a step (h), if the sequential write ratio is higher than a first threshold value, a first file is written to the state solid drive, or if the sequential write ratio is lower than the first threshold value, a second file is written to the state solid drive, wherein a size of the first file is larger than a size of the second file.

In an embodiment, the writing management method further comprises a step of judging if a sum of the logic block address and the sector count of the j-th write command is equal to the logical block address of the (j+1)-th write command, the sequential write count value is increased by 1.

In an embodiment, the size of the first file is larger than the size of one sector of the state solid drive, and the size of the second file is smaller than the size of one sector of the state solid drive.

In accordance with another aspect of the present invention, there is provided a writing management method of a state solid drive. The writing management method includes the following steps. Firstly, plural write commands are transmitted to a firmware so as to write at least one data to the solid state drive, wherein each of the plural write commands contains a logical block address and a sector count. Then, the logical block addresses and the sector counts of the plural write commands are sequentially stored to the firmware. Then, an application program sequentially reads the logical block addresses and the sector counts of the plural write commands. Then, a sequential write ratio is determined according to the logical block addresses and the sector counts. Afterwards, the application program updates the firmware to a first firmware according to the sequential write ratio.

In an embodiment, if the sequential write ratio is higher than a second threshold value, the firmware is updated in a low-resolution mapping mode to implement address conversion.

In an embodiment, if the sequential write ratio is lower than a second threshold value, the firmware is updated in a high-resolution mapping mode to implement address conversion.

In an embodiment, if the sequential write ratio is in a threshold range, the firmware is updated in a hybrid mapping mode to implement address conversion.

In an embodiment, the plural write commands are generated in a specified time interval.

In accordance with another aspect of the present invention, there is provided a writing management method of a state solid drive. The writing management method includes the following steps. Firstly, plural write commands are transmitted to a firmware so as to write at least one data to the solid state drive, wherein each of the plural write commands contains a logical block address and a sector count. Then, the firmware determines a sequential write ratio of the plural write commands so as to generate a firmware update recommendation. Then, an application program reads the firmware update recommendation and updates the firmware to a first firmware according to the firmware update recommendation.

In an embodiment, if the sequential write ratio is higher than a second threshold value, the firmware is updated in a low-resolution mapping mode to implement address conversion.

In an embodiment, if the sequential write ratio is lower than a second threshold value, the firmware is updated in a high-resolution mapping mode to implement address conversion.

In an embodiment, if the sequential write ratio is in a threshold range, the firmware is updated in a hybrid mapping mode to implement address conversion.

In an embodiment, the plural write commands are generated in a specified time interval.

In accordance with another aspect of the present invention, there is provided a writing management system. The writing management system includes a solid state drive, a firmware and an application program. The firmware receiving plural write commands so as to write at least one data to the solid state drive, and determining a sequential write ratio of the plural write commands so as to generate a firmware update recommendation. The application program reads the firmware update recommendation and updates the firmware as a first firmware according to the firmware update recommendation.

In an embodiment, each of the plural write commands contains a logical block address and a sector count.

In an embodiment, the plural write commands include at least one sequential write command and at least one random write command.

In an embodiment, after a number of the at least one sequential write command is divided by a number of the plural write commands, the sequential write ratio is obtained.

In an embodiment, the first firmware implements address conversion in a low-resolution mapping mode.

In an embodiment, the first firmware implements address conversion in a high-resolution mapping mode.

In an embodiment, the first firmware implements address conversion in a hybrid mapping mode.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a writing management system according to a first embodiment of the present invention;

FIG. 2 is a schematic functional block diagram illustrating a writing management system according to a second embodiment of the present invention;

FIGS. 3-1 and 3-2 are a flowchart illustrating a writing management method according to a third embodiment of the present invention;

FIG. 4 is a flowchart illustrating a writing management method according to a fourth embodiment of the present invention; and

FIG. 5 is a flowchart illustrating a writing management method according to a fifth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. In the following embodiments and drawings, the elements irrelevant to the concepts of the present invention are omitted and not shown. For well understanding the present invention, the elements shown in the drawings are not in scale with the elements of the practical product.

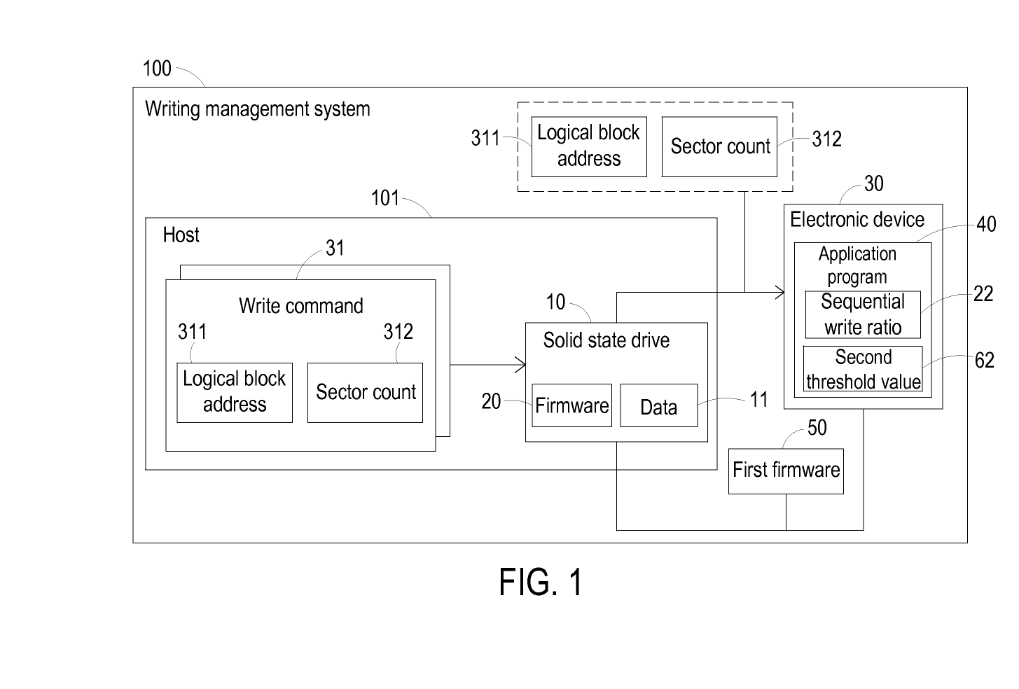

FIG. 1 is a schematic functional block diagram illustrating a writing management system according to a first embodiment of the present invention. As shown in FIG. 1, the writing management system 100 comprises a solid state drive 10, a firmware 20 and an application program 40. The application program 40 is installed in an electronic device 30. The solid state drive 10 comprises a NAND-based flash memory (not shown). The solid state drive 10 is electrically connected with a motherboard of a host 101 through a SATA interface (not shown). The firmware 20 is a program code and it is stored in the solid state drive 10, for example in a reserved block of the NAND-based flash memory. Through the firmware 20, the user can inquire the operating status of the solid state drive 10 or set, update and adjust the solid state drive 10. An example of the electronic device 30 includes but is not limited to a personal computer, a tablet computer or a smart phone. The electronic device 30 is in communication with the host 101 through the internet.

When the host 101 wants to store at least one data 11 to the solid state drive 10, plural write commands 31 containing the data 11 are firstly transmitted from the host 101 to the firmware 20, and then the data 11 is written from the firmware 20 into the NAND-based flash memory of the solid state drive 10 according to the write commands 31. Each of the write commands 31 contains a logical block address 311 and a sector count 312. The logical block address 311 is used for indicating the start address of the logic block to be written. The sector count 312 is used for indicating the number of sectors to be written. For example, if the logical block address 311 of the write command 31 is “100” and the sector count 312 is “5”, the data can be written into the five blocks 100, 101, 102, 103 and 104 of the logical block address 311. Moreover, all of the logical block address 311 and the sector counts 312 will be stored from the firmware 20 to a reserved block of the NAND-based flash memory.

After a certain time interval, the logical block addresses 311 and the sector counts 312 of plural write commands 31 have been stored into the firmware 20. Then, the application program 40 of the electronic device 30 reads the logical block addresses 311 and the sector counts 312 from the firmware 20, and determines a sequential write ratio 22 according to these write commands 31. According to the sequential write ratio 22, the firmware 20 is updated to a first firmware 50 by the application program 40. The first firmware 50 is a firmware for implementing the address conversion in a high-resolution mapping mode, a low-resolution mapping mode or a hybrid mapping mode. The way of updating the firmware may be implemented through a network or a USB interface. The way of updating the firmware is well known to those skilled in the art, and is not redundantly described herein.

Moreover, these write commands 31 comprise at least one sequential write command and at least one random write command. After the number of the at least one sequential write command is divided by the number of the plural write commands 31, the sequential write ratio 22 is obtained. In this context, the sequential write commands can be simply identified by judging whether two consecutive write commands are written into the adjacent logical block addresses. For example, (100, 5) and (105, 3) are the examples of sequential write commands. The two numbers in brackets indicate the logical block address 311 and the sector count 312, respectively.

Preferably, a second threshold value 62 is defined in the application program 40. If the application program 40 judges that the sequential write ratio 22 is higher than the second threshold value 62, the firmware 20 is updated in the low-resolution mapping mode to implement the address conversion. Whereas, if the application program 40 judges that the sequential write ratio 22 is not higher than the second threshold value 62, the firmware 20 is updated in the high-resolution mapping mode to implement the address conversion. More especially, if the sequential write ratio 22 is in a threshold range, the firmware 20 is updated in the hybrid mapping mode to implement the address conversion.

In the above embodiment, the electronic device 30 and the host 101 are different devices. It is noted that the electronic device 30 and the host 101 are not restricted to different devices. For example, in another embodiment, the application program 40 is installed in the host 101, and the host 101 is able to update the firmware through the writing management system of the present invention.

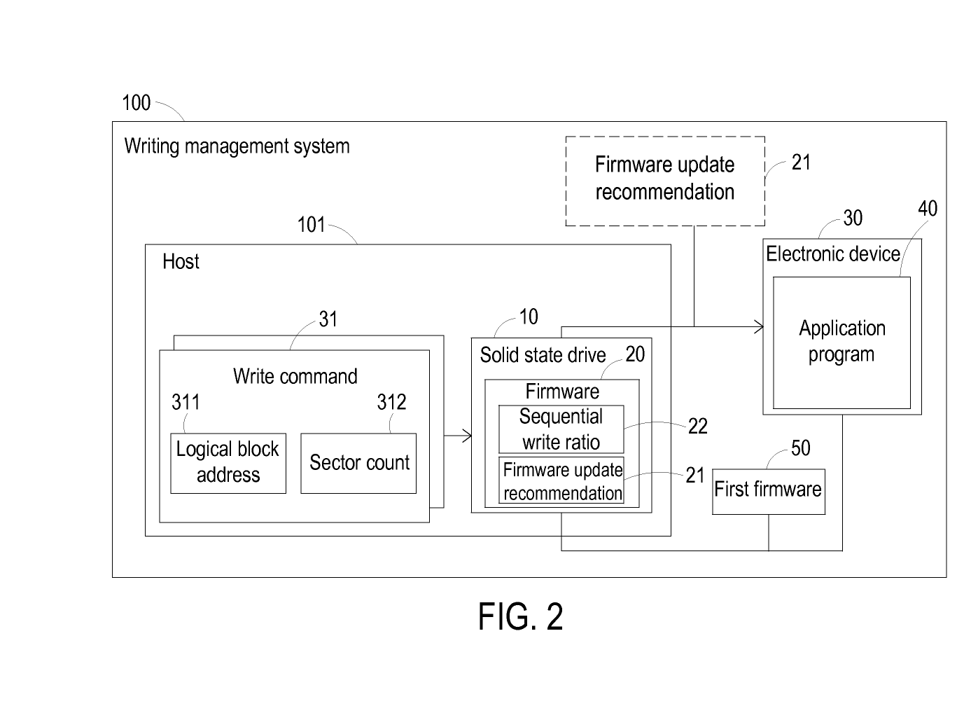

FIG. 2 is a schematic functional block diagram illustrating a writing management system according to a second embodiment of the present invention. As shown in FIG. 2, the writing management system 100 comprises a solid state drive 10, a firmware 20 and an application program 40. The application program 40 is installed in an electronic device 30.

When the user wants to store a data to the solid state drive 10, plural write commands 31 containing the data are firstly transmitted from the host 101 to the firmware 20. Then, the firmware 20 determines a sequential write ratio 22 according to the plural write commands 31, and generates a firmware update recommendation 21 according to the sequential write ratio 22. After the firmware update recommendation 21 is read by the application program 40, the firmware 20 is updated to a first firmware 50 by the application program 40 according to the firmware update recommendation 21.

Each of the write commands 31 contains a logical block address 311 and a sector count 312. The way of generating the sequential write ratio 22 and the type of the first firmware 50 are similar to those described in the first embodiment, and are not redundantly described herein.

In comparison with the first embodiment, the writing management system of this embodiment generates the firmware update recommendation 21 through the firmware 20. In accordance with the benefit of this embodiment, it is not necessary to have an additional space to store the write commands 31. That is, the firmware 20 of the writing management system of this embodiment only has to judge whether there is a sequential write relationship between any two adjacent write commands 31. If the firmware 20 judges that there is a sequential write relationship between any two adjacent write commands 31, the count value is accumulated by a register. Moreover, after the accumulated count value is divided by the number of the plural write commands 31, the sequential write ratio 22 is obtained.

In the above two embodiments, the user can set a specified time interval to collect the write commands of the solid state drive. For example, the specified time interval may be one day, one week or one month. By collecting the writing actions of the solid state drive in the specified time interval, the application program can realize the frequently-used write mode of this solid state drive and update the firmware to a more suitable first firmware according to the write mode. Consequently, after the firmware is updated, the write mode of the solid state drive is close to the real writing action. Under this circumstance, the accessing life of the solid state drive is prolonged, and the accessing performance of the solid state drive is enhanced.

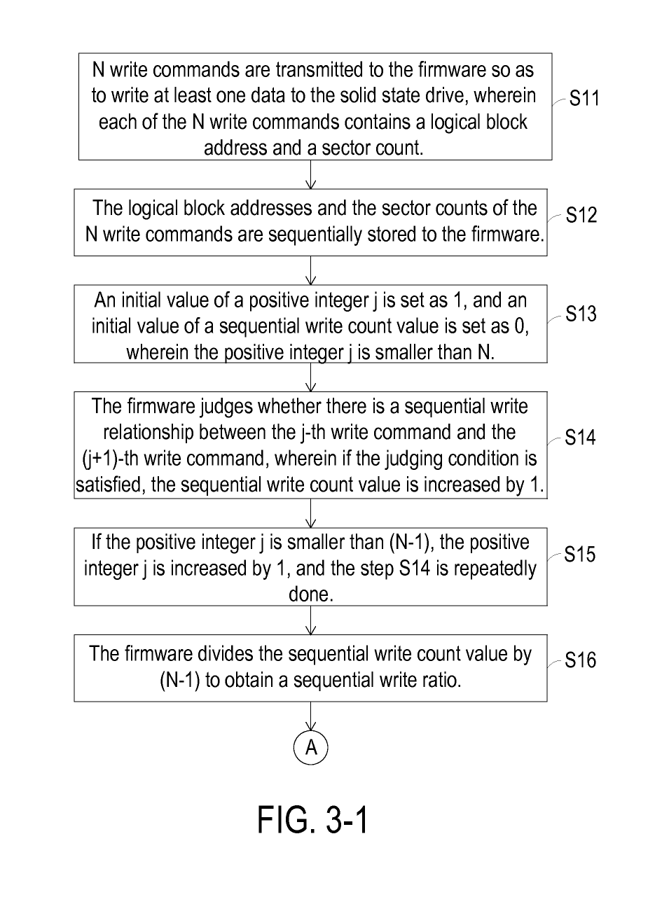

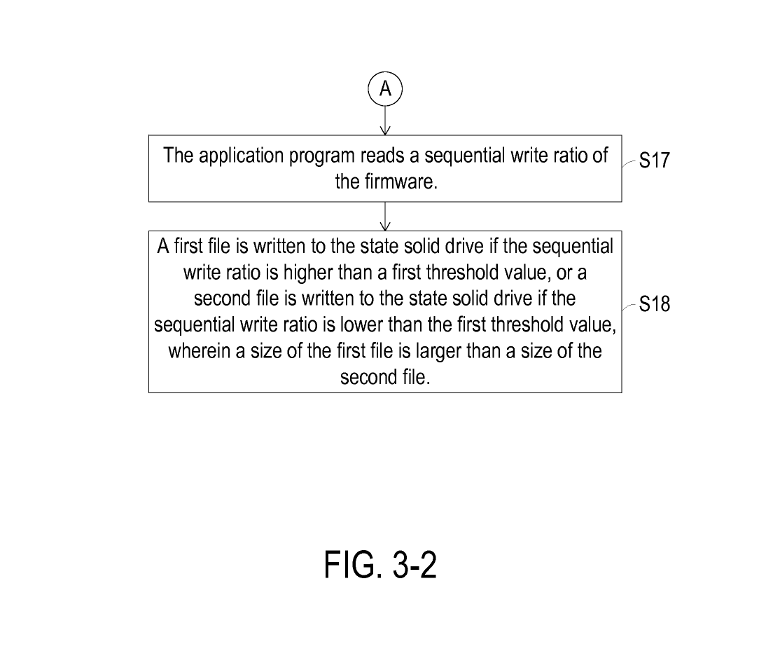

FIGS. 3-1 and 3-2 are a flowchart illustrating a writing management method according to a third embodiment of the present invention. The writing management method is applied to the solid state drive and a firmware for controlling the solid state drive. The writing management method comprises the following steps.

In a step S11, N write commands are transmitted to the firmware so as to write at least one data to the solid state drive, wherein each of the N write commands contains a logical block address and a sector count.

In a step S12, the logical block addresses and the sector counts of the N write commands are sequentially stored to the firmware.

In a step S13, an initial value of a positive integer j is set as 1, and an initial value of a sequential write count value is set as 0, wherein the positive integer j is smaller than N.

In a step S14, the firmware judges whether there is a sequential write relationship between the j-th write command and the (j+1)-th write command, wherein if the judging condition is satisfied, the sequential write count value is increased by 1.

In a step S15, if the positive integer j is smaller than (N−1), the positive integer j is increased by 1, and the step S14 is repeatedly done.

In a step S16, the firmware divides the sequential write count value by (N−1) to obtain a sequential write ratio.

In particular, if the firmware in the step S14 judges that the sum of the logic block address and the sector count of the j-th write command is equal to the logical block address of the (j+1)-th write command, the sequential write count value is increased by 1.

In a step S17, the application program reads a sequential write ratio of the firmware.

In a step S18, a first file is written to the state solid drive if the sequential write ratio is higher than a first threshold value, or a second file is written to the state solid drive if the sequential write ratio is lower than the first threshold value, wherein a size of the first file is larger than a size of the second file.

In particular, the size of the first file is larger than the size of one sector of the state solid drive, and the size of the second file is smaller than the size of one sector of the state solid drive. It is noted that the way of obtaining the sequential write ratio is not restricted. For example, the sequential write ratio may be obtained by the firmware according to different algorithms.

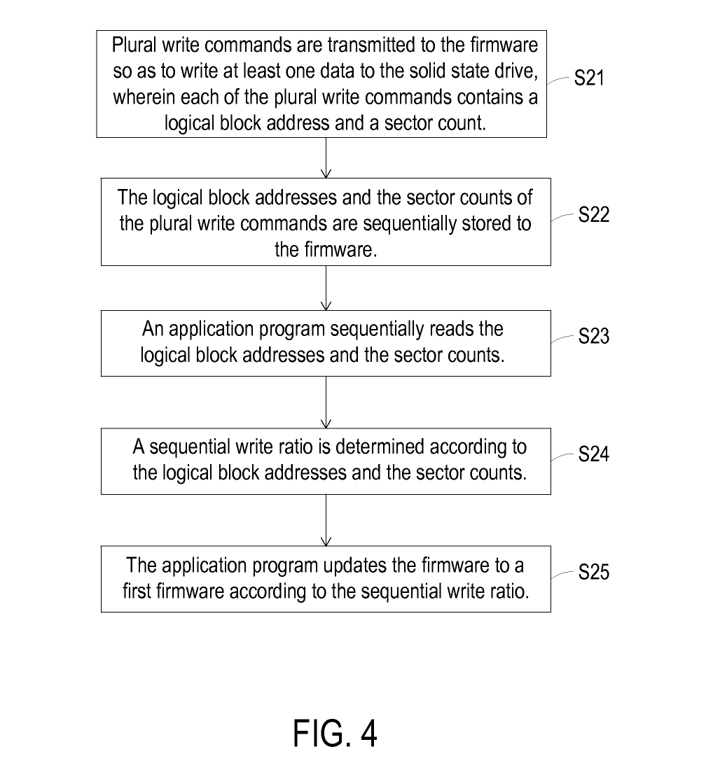

FIG. 4 is a flowchart illustrating a writing management method according to a fourth embodiment of the present invention. The writing management method is applied to the solid state drive and a firmware for controlling the solid state drive. The writing management method comprises the following steps.

In a step S21, plural write commands are transmitted to the firmware so as to write at least one data to the solid state drive, wherein each of the plural write commands contains a logical block address and a sector count, and the plural write commands are generated in a specified time interval (e.g., one hour, one day or one week).

In a step S22, the logical block addresses and the sector counts of the plural write commands are sequentially stored to the firmware.

In a step S23, an application program sequentially reads the logical block addresses and the sector counts.

In a step S24, a sequential write ratio is determined according to the logical block addresses and the sector counts.

In a step S25, the application program updates the firmware to a first firmware according to the sequential write ratio.

If the sequential write ratio is higher than a second threshold value in the step S25, the write data is possibly in the same block. Consequently, the firmware is updated in a low-resolution mapping mode to implement address conversion.

If the sequential write ratio is lower than the second threshold value in the step S25, the write data is possibly distributed in different blocks. Consequently, the firmware is updated in a high-resolution mapping mode to implement address conversion.

If the sequential write ratio is in a threshold range in the step S25, the firmware is updated in a hybrid mapping mode to implement address conversion. The threshold range may be defined by the user.

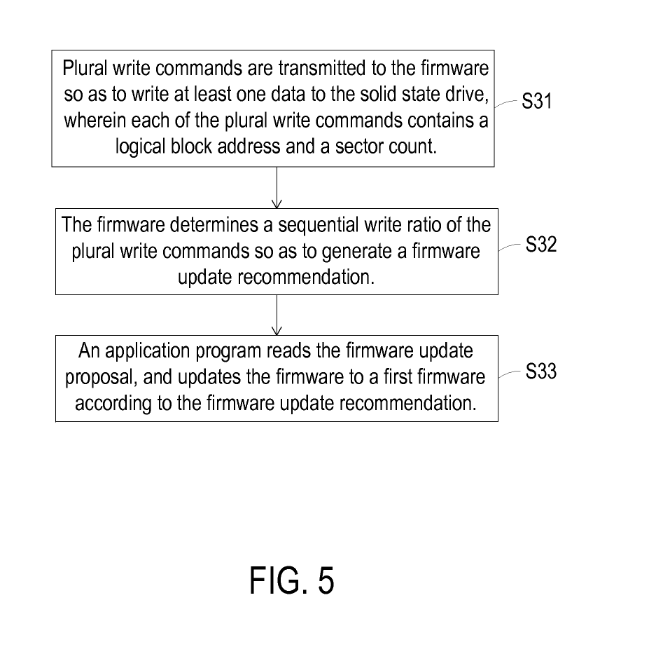

FIG. 5 is a flowchart illustrating a writing management method according to a fifth embodiment of the present invention. The writing management method is applied to the solid state drive and a firmware for controlling the solid state drive. The writing management method comprises the following steps.

In a step S31, plural write commands are transmitted to the firmware so as to write at least one data to the solid state drive, wherein each of the plural write commands contains a logical block address and a sector count, and the plural write commands are generated in a specified time interval.

In a step S32, the firmware determines a sequential write ratio of the plural write commands so as to generate a firmware update recommendation.

In a step S33, an application program reads the firmware update recommendation, and updates the firmware to a first firmware according to the firmware update recommendation.

If the sequential write ratio is higher than a second threshold value in the step S33, the firmware is updated in a low-resolution mapping mode to implement address conversion.

If the sequential write ratio is lower than a second threshold value in the step S33, the firmware is updated in a high-resolution mapping mode to implement address conversion.

If the sequential write ratio is in a threshold range, the firmware is updated in a hybrid mapping mode to implement address conversion.

From the above descriptions, the present invention provides a writing management method and a writing management system for a solid state drive. According to a write mode of the solid state drive, a corresponding firmware is generated. By updating the firmware, the accessing life of the solid state drive is prolonged, and the accessing performance of the solid state drive is enhanced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A writing management method of a solid state drive, the writing management method comprising steps of:
(a) transmitting N write commands to a firmware so as to write at least one data to the solid state drive, wherein each of the N write commands contains a logical block address and a sector count;
(b) sequentially storing the logical block addresses and the sector counts of the N write commands to the firmware;
(c) setting an initial value of a positive integer j as 1, and setting an initial value of a sequential write count value as 0, wherein the positive integer j is smaller than N;
(d) judging whether there is a sequential write relationship between the j-th write command and the (j+1)-th write command by the firmware, wherein if there is the sequential write relationship, the sequential write count value is increased by 1;
(e) if the positive integer j is smaller than (N−1), increasing the positive integer j by 1 and repeatedly performing the step (d);
(f) dividing the sequential write count value by (N−1) to obtain a sequential write ratio by the firmware;
(g) allowing an application program to read the sequential write ratio of the firmware; and
(h) if the sequential write ratio is higher than a first threshold value, writing a first file to the state solid drive; or
if the sequential write ratio is lower than the first threshold value, writing a second file to the state solid drive;
wherein a size of the first file is larger than a size of the second file.

2. The writing management method according to claim 1, further comprising step of judging if a sum of the logic block address and the sector count of the j-th write command is equal to the logical block address of the (j+1)-th write command, the sequential write count value is increased by 1.

3. The writing management method according to claim 1, wherein the size of the first file is larger than a size of one sector of the state solid drive, and the size of the second file is smaller than the size of one sector of the state solid drive.

4. A writing management method of a state solid drive, the writing management method comprising steps of:
transmitting plural write commands to a firmware so as to write at least one data to the solid state drive, wherein each of the plural write commands contains a logical block address and a sector count;
sequentially storing the logical block addresses and the sector counts of the plural write commands to the firmware;
allowing an application program to sequentially read the logical block addresses and the sector counts of the plural write commands;
determining a sequential write ratio according to the logical block addresses and the sector counts; and
allowing the application program to update the firmware to a first firmware according to the sequential write ratio.

5. The writing management method according to claim 4, wherein if the sequential write ratio is higher than a second threshold value, the firmware is updated in a low-resolution mapping mode to implement address conversion.

6. The writing management method according to claim 4, wherein if the sequential write ratio is lower than a second threshold value, the firmware is updated in a high-resolution mapping mode to implement address conversion.

7. The writing management method according to claim 4, wherein if the sequential write ratio is in a threshold range, the firmware is updated in a hybrid mapping mode to implement address conversion.

8. The writing management method according to claim 4, wherein the plural write commands are generated in a specified time interval.

9. A writing management method of a state solid drive, the writing management method comprising steps of:
transmitting plural write commands to a firmware so as to write at least one data to the solid state drive, wherein each of the plural write commands contains a logical block address and a sector count;
determining a sequential write ratio of the plural write commands by the firmware so as to generate a firmware update recommendation; and
allowing an application program to read the firmware update recommendation and update the firmware to a first firmware according to the firmware update recommendation.

10. The writing management method according to claim 9, wherein if the sequential write ratio is higher than a second threshold value, the firmware is updated in a low-resolution mapping mode to implement address conversion.

11. The writing management method according to claim 9, wherein if the sequential write ratio is lower than a second threshold value, the firmware is updated in a high-resolution mapping mode to implement address conversion.

12. The writing management method according to claim 9, wherein if the sequential write ratio is in a threshold range, the firmware is updated in a hybrid mapping mode to implement address conversion.

13. The writing management method according to claim 9, wherein the plural write commands are generated in a specified time interval.

14. A writing management system, comprising:
a solid state drive;
a firmware receiving plural write commands so as to write at least one data to the solid state drive, and determining a sequential write ratio of the plural write commands so as to generate a firmware update recommendation; and
an application program reading the firmware update recommendation and updating the firmware as a first firmware according to the firmware update recommendation.

15. The writing management system according to claim 14, wherein each of the plural write commands contains a logical block address and a sector count.

16. The writing management system according to claim 14, wherein the plural write commands is composed of at least one sequential write command and at least one random write command.

17. The writing management system according to claim 16, wherein after a number of the at least one sequential write command is divided by a number of the plural write commands, the sequential write ratio is obtained.

18. The writing management system according to claim 14, wherein the first firmware implements address conversion in a low-resolution mapping mode.

19. The writing management system according to claim 14, wherein the first firmware implements address conversion in a high-resolution mapping mode.

20. The writing management system according to claim 14, wherein the first firmware implements address conversion in a hybrid mapping mode.
